(19) United States
(12) Patent Application Publication
(10) Pub. No.: US 2015/0088873 A1
(43) Pub. Date: Mar. 26, 2015

(54) METHOD AND APPARATUS FOR SEARCHING FOR CONTENT

(71) Applicant: SAMSUNG ELECTRONICS CO., LTD., Suwon-si (KR)

(72) Inventor: Do-han KIM, Suwon-si (KR)

(73) Assignee: SAMSUNG ELECTRONICS CO., LTD., Suwon-si (KR)

(21) Appl. No.: 14/493,461

(22) Filed: Sep. 23, 2014

(30) Foreign Application Priority Data
Sep. 23, 2013 (KR) 10-2013-0112866

(51) Int. Cl. G06F 17/30; G06F 3/0484; G06F 3/0482

(52) U.S. Cl. CPC G06F 17/30528; G06F 3/0482; G06F 3/04842
USPC 707/725; 707/722

(57) ABSTRACT

A method by which a device searches for content is provided. The method includes: receiving a user input selecting a certain date among a plurality of dates included in a calendar displayed on a screen of the device; displaying a menu including at least one content search condition according to the selection of the date; receiving a user input selecting a content search condition from among the at least one content search condition included in the menu; searching for pieces of content related to the selected date according to the selected content search condition; and displaying found pieces of content according to a result of the searching.

### CROSS-REFERENCE TO RELATED APPLICATION(S)

This application claims priority from Korean Patent Application No. 10-2013-0112866, filed on Sep. 23, 2013 in the Korean Intellectual Property Office, the disclosure of which is incorporated herein in its entirety by reference.

### BACKGROUND

1. Field

Apparatuses and methods consistent with exemplary embodiments relate to providing a method and apparatus for searching for content.

2. Description of the Related Art

Along with the recent development of multimedia and communication technologies, a user may use content in various environments by using a plurality of devices. In addition, along with the recent flow of digital convergence, a smart phone has not only a telephone function, but additional various functions, such as an Internet communication function, a digital camera function, an MP3 player function, a game function, a broadcast watch function, and a financial transaction function. Accordingly, a device may generate and reproduce a great amount of content. Thus, there is an increased demand for a device which efficiently and easily searches a large amount of content for content desired by a user.

### SUMMARY

One or more exemplary embodiments include a content search method of searching for content according to a date-based content search condition and generating an album including the content based on the search result.

According to an aspect of an exemplary embodiment, there is provided a method by which a device searches for content, the method including: receiving a user input selecting a certain date included in a calendar displayed on a screen of the device; displaying a menu including at least one content search condition according to the selection of the date; receiving a user input selecting a content search condition from among the at least one content search condition included in the menu; searching for pieces of content related to the selected date according to the selected content search condition; and displaying found pieces of content according to a result of the searching.

The at least one content search condition may include at least one condition selected from the group consisting of a condition for searching for the pieces of content related to the selected date on a yearly basis and a condition for searching for the pieces of content related to the selected date on a monthly basis.

The pieces of content related to the selected date may include pieces of content generated by the device on the selected date.

The pieces of content related to the selected date may include pieces of content reproduced by the device on the selected date.

The displaying the found pieces of content may include displaying the found pieces of content by sorting the found pieces of content on a yearly or monthly basis.

The method may further include: receiving a user input selecting at least one of the displayed pieces of content; and generating an album including the selected pieces of content.

The generating the album may include generating at least one album selected from the group consisting of an e-book including the selected pieces of content, a motion graphics interchange format (GIF) file including the selected pieces of content, and a list of the selected pieces of content.

The content may include at least one content selected from the group consisting of a still image, a video, music, a call record, a text record, and a data use record.

Types of the pieces of content related to the selected date may be displayed in a field in which the date included in the calendar is displayed.

According to an aspect of another exemplary embodiment, there is provided a device including: a memory configured to store at least one program; and a processor configured to execute the at least one program such that the device searches for content, wherein the at least one program may include instructions for executing: receiving a user input selecting a certain date included in a calendar displayed on a screen of the device; displaying a menu including at least one content search condition according to the selection of the date; receiving a user input selecting a content search condition from among the at least one content search condition included in the menu; searching for pieces of content related to the selected date according to the selected content search condition; and displaying found pieces of content according to a result of the searching.

The content search condition may include at least one condition selected from the group consisting of a condition for searching for the pieces of content related to the selected date on a yearly basis and a condition for searching for the pieces of content related to the selected date on a monthly basis.

The pieces of content related to the selected date may include pieces of content generated by the device on the selected date.

The pieces of content related to the selected date may include pieces of content reproduced by the device on the selected date.

The displaying the found pieces of content may include displaying the found pieces of content by sorting the found pieces of content on a yearly or monthly basis.

The at least one program may further include instructions for executing: receiving a user input selecting at least one of the displayed pieces of content; and generating an album including the selected pieces of content.

The generating the album may include generating at least one album selected from the group consisting of an e-book including the selected pieces of content, a motion graphics interchange format (GIF) file including the selected pieces of content, and a list of the selected pieces of content.

The content may include at least one content selected from the group consisting of a still image, a video, music, a call record, a text record, and a data use record.

Types of the pieces of content related to the selected date may be displayed in a field in which the date included in the calendar is displayed.

According to an aspect of another exemplary, there is provided a non-transitory computer readable medium having recorded thereon a program which, when executed by a computer, performs a method including: displaying a calendar including a plurality of dates; receiving a first input selecting a date among the plurality of dates; displaying a menu including at least one search condition in response to receiving the input for selecting the date; receiving a second input selecting a search condition among the at least one search condition; searching for content related to the selected date and the selected search condition; and displaying a result of the searching, wherein the at least one search condition includes a monthly search condition and a yearly search condition.

The plurality of dates may include a plurality of days in a specified month and specified year and the selected date corresponds to a specified day in the specified month and specified year.

In response to the monthly search condition being selected, the searching for content may include searching for content related to the specified day in at least one month other than the specified month.

In response to the yearly search condition being selected, the searching for content may include searching for content related to the specified day in the specified month in at least one year other than the specified year.

The content related to the selected date may include at least one of content generated on the selected date and content reproduced on the selected date.

### BRIEF DESCRIPTION OF THE DRAWINGS

The above and/or other aspects will become more apparent and more readily appreciated from the following description of certain exemplary embodiments, taken in conjunction with the accompanying drawings in which:

FIG. 1 is a block diagram of a device according to an exemplary embodiment;

FIG. 2 is a flowchart of a method by which the device searches for content, according to an exemplary embodiment;

FIG. 3 is an example in which a certain date included in a calendar displayed on a screen of a device is selected, according to an exemplary embodiment;

FIG. 4 is an example in which a menu for selecting a content search condition is displayed on a screen of a device, according to an exemplary embodiment;

FIG. 5 is an example in which found pieces of content are displayed on a screen of a device, according to an exemplary embodiment;

FIG. 6 is a block diagram of a device according to an exemplary embodiment;

FIG. 7 is a flowchart of a method by which the device searches for content, according to an exemplary embodiment;

FIG. 8 is an example in which at least one of a plurality of pieces of content displayed on a screen of a device is selected, according to an exemplary embodiment; and

FIG. 9 is an example in which an album including pieces of content is displayed on a screen of a device, according to an exemplary embodiment.

### DETAILED DESCRIPTION

The present disclosure may allow various kinds of change or modification and various changes in form, and certain exemplary embodiments will be illustrated in drawings and described in detail in the specification. However, it should be understood that the exemplary embodiments do not limit the present disclosure to a specific disclosed form but include every modified, equivalent, or replaced one within the spirit and technical scope of the exemplary embodiments.

Although terms, such as ‘first’ and ‘second’, can be used to describe various elements, the elements cannot be limited by the terms. The terms can be used to classify a certain element from another element.

The terminology used in the application is used only to describe certain exemplary embodiments and does not limit the exemplary embodiments. An expression in the singular includes an expression in the plural unless they are clearly different from each other in context. In the application, it should be understood that terms, such as ‘include’ and ‘have’, are used to indicate the existence of an implemented feature, number, step, operation, element, part, or a combination thereof without excluding in advance the possibility of the existence or addition of one or more other features, numbers, steps, operations, elements, parts, or combinations thereof.

Reference will now be made in detail to certain exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

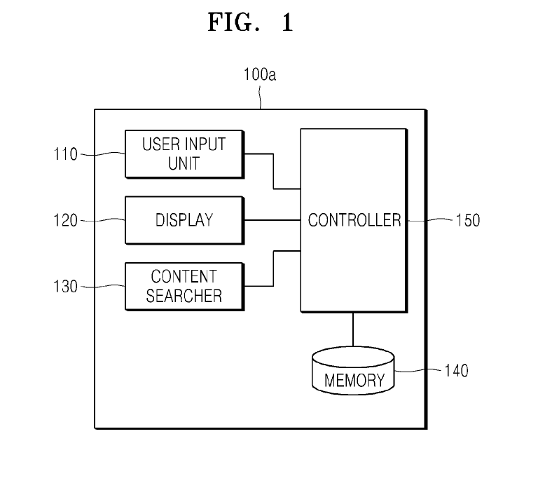

FIG. 1 is a block diagram of a device 100a according to an exemplary embodiment.

As shown in FIG. 1, the device 100a may include a user input unit 110, a display 120, a content searcher 130, a memory 140, and a controller (or processor) 150.

The user input unit 110 may receive a user input to the device 100a. The user input unit 110 may receive a touch input of a user. In this case, the user input unit 110 include a touch screen of the device 100a that senses and receives a touch input of the user but is not limited thereto.

In addition, the user input unit 110 may receive a user input of moving the device 100a. For instance, the user input unit 110 may include a motion sensor that senses a motion of the device 100a by using, for example, a gyro sensor, a gravity sensor, or a motion sensor but is not limited thereto.

For example, the user input unit 110 may include a keypad, a dome switch, a touch pad (e.g., capacitive overlay, resistive overlay, infrared beam, surface acoustic wave, integral strain gauge, piezoelectric, or the like), a jog wheel, a jog switch, and the like but is not limited thereto.

A user input received by the user input unit 110 may be used for the device 100a to select a certain date (i.e. among a plurality of dates) included in a calendar displayed on a screen of the device 100a. A user input received by the user input unit 110 may be used for the device 100a to select a content search condition included in a menu. According to another exemplary embodiment, a user input received by the user input unit 110 may be used for the device 100a to select at least one of a plurality of displayed pieces of content.

The display 120 displays information processed by the device 100a. The display 120 may display pieces of content found by the device 100a. In this case, the display 120 may display the found pieces of content on a yearly or monthly basis according to the selected content search condition.

The display 120 may display a calendar including a certain date. In this case, the display 120 may display types of pieces of content related to the date in a field in which the date included in the calendar is displayed.

The display 120 may display a menu for selecting a content search condition according to the selection of the date.

When a touch screen is formed by a layered structure of the display 120 and a touch pad, the display 120 may also be used as an input device (i.e., a touchscreen). The display 120 may include at least one display selected from the group consisting of a liquid crystal display, a thin-film transistor liquid crystal display, an organic light-emitting diode display, a flexible display, and a three-dimensional (3D) display. However, the embodiments are not limited thereto. According to an implementation form of the device 100a, the device 100a may include two or more displays 120. In this case, the two or more displays 120 may be disposed to face each other by using a hinge.

The content searcher 130 searches for pieces of content related to the selected date according to the content search condition.

The memory 140 stores various kinds of content data for the device 100a to search for and display pieces of content related to the selected date according to the content search condition. The memory 140 may store programs for processing and control of the controller 150 and store input/output data. In addition, to being stored in the memory, the content may be stored remotely, e.g., in a cloud, a remote server, another device, etc.

The memory 140 may include storage medium such as a flash memory type memory, a hard disk type memory, a multimedia card micro type memory, a card type memory (e.g., a secure digital (SD) memory, an extreme digital (XD) memory, or the like), RAM, static RAM (SRAM), ROM, electrically erasable programmable ROM (EEPROM), programmable ROM (PROM), a magnetic memory, a magnetic disk, and an optical disc. The device 100a may operate a web storage for performing a storage function of the memory 140 over the Internet.

The programs stored in the memory 140 may be classified into a plurality of modules according to functions thereof, e.g., a user interface (UI) module, a touch screen module, and the like.

The UI module may provide a UI, a graphical UI (GUI), or the like specified to cooperate with the device 100a on an application basis. A function of the UI module may be inferred by those of ordinary skill in the art from the name thereof, and thus, a detailed description thereof is omitted.

The touch screen module may detect a touch gesture of the user on the touch screen and transmit information on the touch gesture to the controller 150. The touch screen module may be formed by a separate controller (e.g., separate hardware).

To detect a touch or a proximity touch on the touch screen, various sensors may be included inside or near the touch screen. An example of the sensors for detecting a touch on the touch screen is a tactile sensor. The tactile sensor is a sensor for detecting contact (e.g., by a user's finger). The tactile sensor may detect various pieces of information, such as the roughness of a contact surface, the hardness of a contact object, a temperature of a contact point, and the like.

Another example of the sensors for detecting a touch on the touch screen is a proximity sensor.

The proximity sensor is a sensor for detecting whether an object approaching a certain detection surface or existing in a near distance exists by using an electromagnetic force or infrared rays without a mechanical contact. Examples of the proximity sensor include a transmissive photoelectric sensor, a direct reflective photoelectric sensor, a mirror reflective photoelectric sensor, a high-frequency oscillation-type proximity sensor, a capacitive proximity sensor, a magnetic proximity sensor, an infrared proximity sensor, and the like. Examples of the touch gesture of the user include tap, touch & hold, double tap, drag, panning, flick, drag & drop, swipe, and the like.

“Tap” indicates an action of the user of touching a finger or a touch tool (e.g., an electronic pen) to a screen and immediately lifting the finger or the touch tool from the screen.

“Touch & hold” indicates an action of the user of touching a finger or a touch tool (e.g., an electronic pen) to a screen and holding the touch for at least a threshold time (e.g., two seconds). That is, a time difference between a touch-in time point and a touch-out time point is the threshold time (e.g., two seconds) or longer. To make the user recognize whether a touch input is tap or touch & hold, a feedback signal may be provided in an auditory or tactile manner when the touch input is held for the threshold time or longer. The threshold time may be changed according to circumstances.

“Double tap” indicates an action of the user of touching a finger or a touch tool (e.g., a stylus) to a screen two times.

“Drag” indicates an action of the user of touching a finger or a touch tool to a screen and moving the finger or the touch tool to another location on the screen while holding the touch. Due to a drag action, an object moves, or a panning action to be described below is performed.

“Panning” indicates an action of the user of performing a drag action without selecting an object. Since a panning action does not select any object, no objects move in a page corresponding to the panning action, and the page itself corresponding to the panning action moves on the screen, or an object group moves in the corresponding page.

“Flick” indicates an action of the user of performing a drag action at a threshold speed (e.g., 100 pixels/s) or faster by using a finger or a touch tool. A drag (or panning) action and a flick action may be distinguished from each other based on whether a moving speed of the finger or the touch tool is the threshold speed (e.g., 100 pixels/s) or faster.

“Drag & drop” indicates an action of the user of dragging an object to a certain location on a screen and dropping the object by using a finger or a touch tool.

“Pinch” indicates an action of the user of moving two fingers in different directions while touching the two fingers to a screen. A pinch action is a gesture for pinch-open or pinch-close of an object or a page, wherein a magnification value or a reduction value is determined according to a distance between the two fingers.

“Swipe” indicates an action of the user of moving a finger or a touch tool in a horizontal or vertical direction by a certain distance while touching an object to a screen with the finger or the touch tool. A motion in a diagonal direction may not be recognized as a swipe action.

The controller 150 typically controls the general operation of the device 100a. That is, the controller 150 may generally control the user input unit 110, the display 120, the content searcher 130, the memory 140, and the like by executing programs stored in the memory 140. Further, the content searcher 130 may be a component of the controller (processor) 150 such that the operations of the content searcher 130 are performed by the controller (processor) 150.

The controller 150 may include an application processor and a communication processor. The application processor may control various kinds of applications stored in the memory 140.

The controller 150 may search for pieces of content related to the selected date according to the selected content search condition. The controller 150 may also sort the found pieces of content on a yearly or monthly basis according to the selected content search condition.

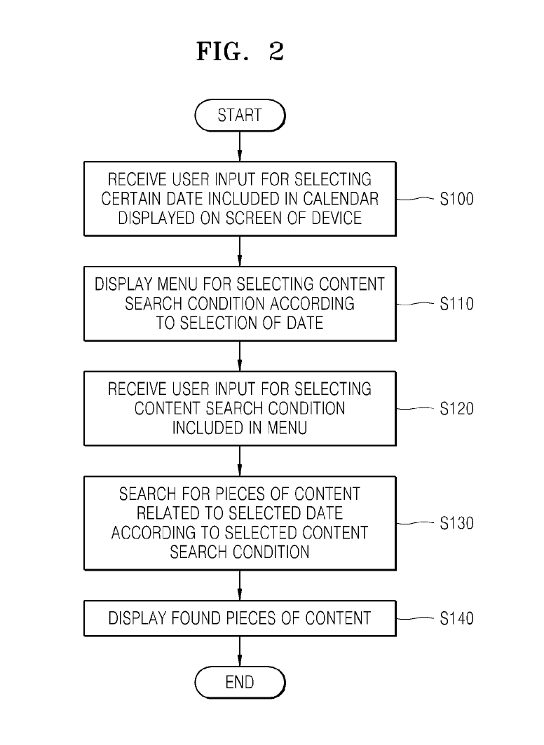

FIG. 2 is a flowchart of a method by which the device 100a searches for content, according to an exemplary embodiment.

In operation S100, the device 100a receives a user input for selecting a certain date included in a calendar displayed on a screen of the device 100a.

For example, the user may select a certain date included in the calendar displayed on the screen of the device 100a. In this case, the user may select at least one of a plurality of displayed dates by touching and holding a certain region on a touch screen in a field where a date to be selected is displayed.

“Touch & hold” indicates an action of the user of touching a finger or a touch tool (e.g., an electronic pen) to a screen and holding the touch for at least the threshold time (e.g., two seconds). That is, a time difference between a touch-in time point and a touch-out time point is the threshold time (e.g., two seconds) or longer. To make the user recognize whether a touch input is tap or touch & hold, a feedback signal may be provided in an auditory or tactile manner when the touch input is held for the threshold time or longer. The threshold time may be changed according to circumstances.

The device 100a may display types of pieces of content related to a date in a field where the date included in the calendar is displayed. For example, the content may include at least one piece of content selected from the group consisting of a still image, a video, music, a call record, a text record, and a data use record. Accordingly, the types of pieces of content may be displayed as, for example, “photo”, “video”, “music”, “calling record”, and “text record”.

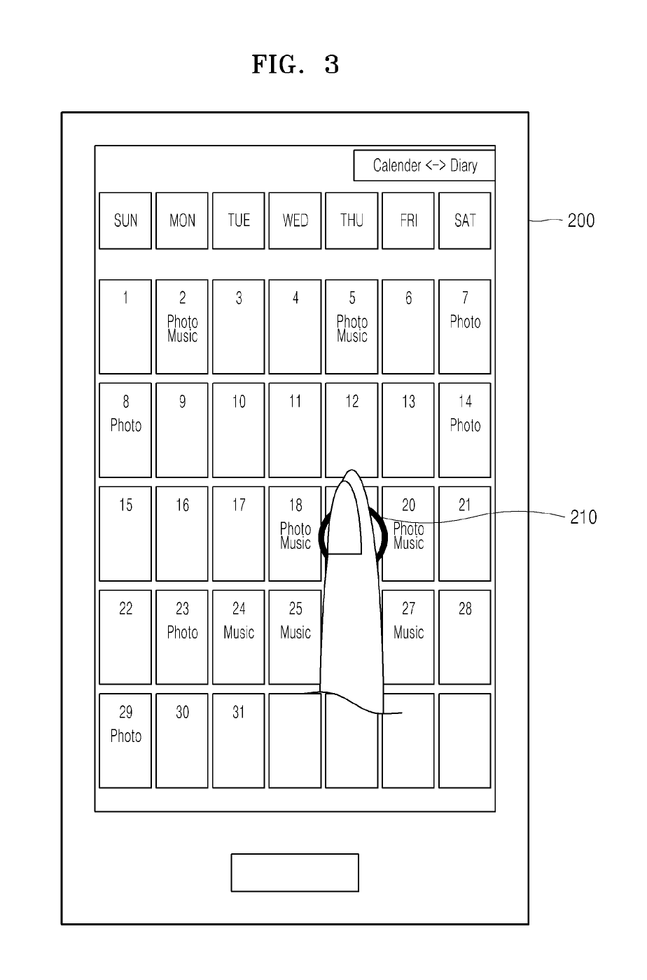

The types of pieces of content will be described below in greater detail with reference to FIG. 3.

In operation S110, the device 100a displays a menu for selecting a content search condition according to the selection of the date.

The device 100a may provide a menu for selecting a content search condition with respect to the date selected by the user. The user may select a content search condition through the menu.

For example, the content search condition may include at least one condition selected from the group consisting of a condition for searching for the pieces of content related to the selected date on a yearly basis and a condition for searching for the pieces of content related to the selected date on a monthly basis.

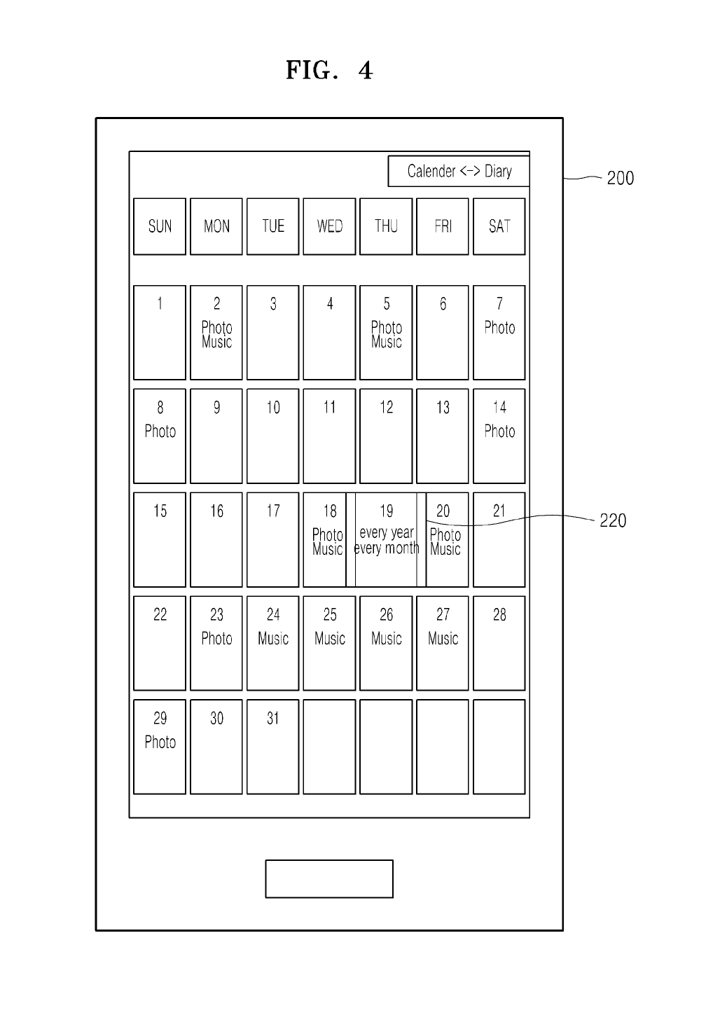

The content search condition will be described below in greater detail with reference to FIG. 4.

In operation S120, the device 100a receives a user input for selecting the content search condition included in the menu.

For example, the user may select at least one of the content search conditions included in the menu. In this case, the user may select at least one of displayed content search conditions by tapping, swiping, or flicking a certain region on the touch screen in a field where the content search condition to be selected is displayed.

In operation S130, the device 100a searches for pieces of content related to the selected date according to the selected content search condition.

The content may include at least one content selected from the group consisting of a still image, a video, music, a call record, a text record, and a data use record.

For example, the pieces of content related to the selected date may include pieces of content generated by the device 100a on the selected date. The pieces of content related to the selected date may include pieces of content reproduced by the device 100a on the selected date.

In operation S140, the device 100a displays the found pieces of content (i.e., a result of the search).

For example, the device 100a may display the found pieces of content by sorting the found pieces of content on a yearly or monthly basis according to the selected content search condition.

The content may include at least one content selected from the group consisting of a still image, a video, music, a call record, a text record, and a data use record.

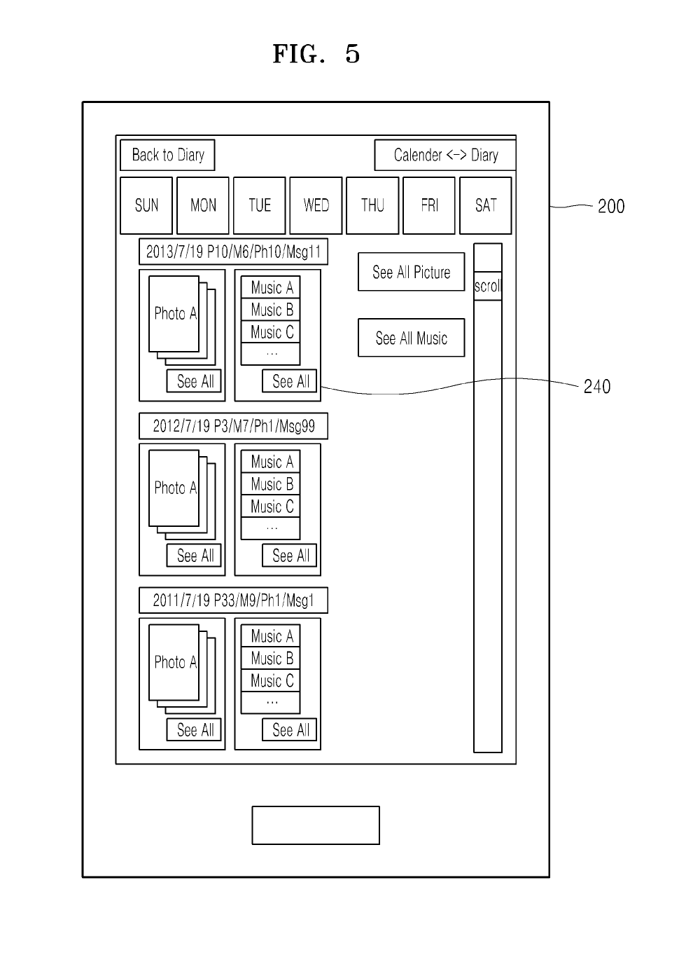

The content will be described below in greater detail with reference to FIG. 5.

FIG. 3 is an example in which a certain date included in a calendar displayed on a screen of a device 200 is selected, according to an exemplary embodiment.

As shown in FIG. 3, the device 200 may provide the calendar including the certain date. The calendar may include a field in which dates are displayed. The field in which dates are displayed is a field from which the user may select the certain date, and the user may select at least one of the displayed dates by touching and holding a certain region in the field on the touch screen.

For example, as shown in FIG. 3, the user may select “July 19” from a calendar indicating July by touching and holding a field 210 where “19” in the calendar is displayed.

Types of pieces of content related to a date may be displayed in a field where the date is displayed. In this case, the content may include at least one content selected from the group consisting of a still image, a video, music, a call record, a text record, and a data use record. Accordingly, the types of pieces of content may be displayed as, for example, “photo”, “video”, “music”, “calling record”, and “text record”.

The pieces of content related to a date may include pieces of content generated by the device 200 on the date. The pieces of content related to the date may also include pieces of content reproduced by the device 200 on the date.

For example, as shown in FIG. 3, “photo” and “music” may be displayed as types of the pieces of content related to a date in a field where “5” is displayed. Accordingly, this indicates that pieces of content generated or reproduced by the device 200 on “July 5” are photos (still images) and music.

FIG. 4 is an example in which a menu 220 for selecting a content search condition is displayed on a screen of the device 200, according to an exemplary embodiment.

When the user touches and holds a field in which “19” is displayed from the calendar indicating July on the device 200, as shown in FIG. 3, the device 200 displays the menu 220 for selecting a content search condition on a screen of the device 200, as shown in FIG. 4. For example, as shown in FIG. 4, the menu 220 for selecting a content search condition may be displayed to overlap a field where a date selected by the user is displayed. Alternatively, the menu 220 for selecting a content search condition may be displayed in a different certain region than the field where the date selected by the user is displayed. However, one or more exemplary embodiments are not limited thereto.

On the menu 220, a content search condition which the user may select may be displayed. The content search condition may include at least one condition selected from the group consisting of a condition for searching for pieces of content related to the selected date on a yearly basis and a condition for searching for pieces of content related to the selected date on a monthly basis. For example, as shown in FIG. 4, the content search condition may be displayed as “every year” for indicating the condition for searching for pieces of content related to the selected date on a yearly basis. Alternatively, the content search condition may be displayed as “every month” for indicating the condition for searching for pieces of content related to the selected date on a monthly basis.

FIG. 5 is an example in which found pieces of content are displayed on a screen of the device 200, according to an exemplary embodiment.

When “July 19” is selected from the calendar as shown in FIG. 3 and “every year” is selected from the menu 220 as shown in FIG. 4, the device 200 may search for pieces of content related to July 19 every year and display the found pieces of content on a screen of the device 200.

For example, as shown in FIG. 5, the device 200 may search for pieces of content related to “July 19, 2011”, “July 19, 2012”, and “July 19, 2013” and display the found pieces of content on a screen of the device 200. In this case, the pieces of content related to “July 19, 2013” may include still images and music generated by the device 200 on “July 19, 2013.” Alternatively, the pieces of content related to “July 19, 2013” may include still images and music reproduced by the device 200 on “July 19, 2013.” In this case, the found pieces of content (illustrated as ‘240’ in FIG. 5) may be sorted and displayed on a yearly basis.

When “July 19” is selected from the calendar as shown in FIG. 3 and “every month” is selected from the menu 220 as shown in FIG. 4, the device 200 may search for pieces of content related to the 19th of every month and display the found pieces of content on a screen of the device 200. The found pieces of content may be displayed on a screen of the device 200 as log information for providing an access to the pieces of content.

For example, the device 200 may search for pieces of content related to “May 19”, “June 19”, and “July 19” and display the found pieces of content on a screen of the device 200. In this case, the pieces of content related to “June 19” may include still images and music generated by the device 200 on “June 19.” Alternatively, the pieces of content related to “June 19” may include still images and music reproduced by the device 200 on “June 19.” In this case, the found pieces of content may be sorted and displayed on a monthly basis. The found pieces of content may be displayed on a screen of the device 200 as log information for providing an access to the pieces of content.

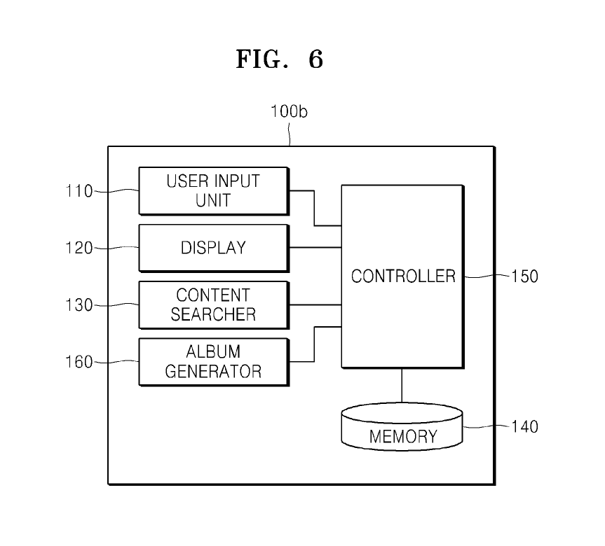

FIG. 6 is a block diagram of a device 100b according to an exemplary embodiment.

As shown in FIG. 6, the device 100b may include a user input unit 110, a display 120, a content searcher 130, a memory 140, and a controller 150, similar to device 100a of FIG. 1, and may further include an album generator 160.

A user input received by the user input unit 110 in the device 100b may be used to select at least one of a plurality of pieces of content displayed on the device 100b.

The album generator 160 may generate an album including the selected pieces of content by using a user input received by the user input unit 110. For example, the album generator 160 may generate at least one album selected from the group consisting of an e-book including the selected pieces of content, a motion graphics interchange format (GIF) file including the selected pieces of content, and a list of the selected pieces of content. Further, the album generator 160 may be a component of the controller (processor) 150 such that the operations of the album generator 160 are performed by the controller (processor) 150.

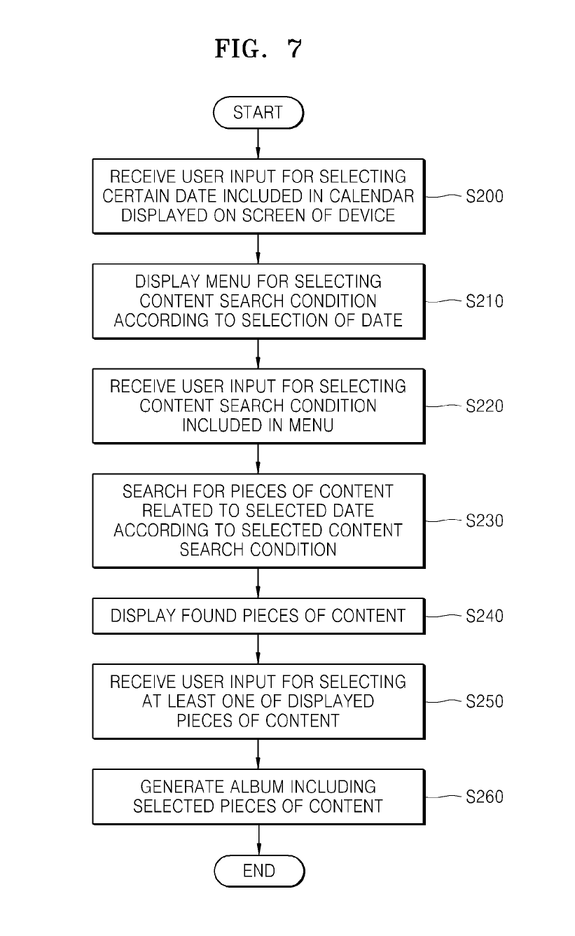

FIG. 7 is a flowchart of a method by which the device 100b searches for content, according to an exemplary embodiment.

Operations S200 to S240 correspond to operations S100 to S140 described above, and thus, repeated description thereof is omitted.

In operation S250, the device 100b receives a user input for selecting at least one of the displayed pieces of content.

For example, the user may select at least one piece of content to be included in an album from among the displayed pieces of content. In this case, the user may select at least one of the displayed pieces of content by tapping, swiping, or flicking a certain region on a touch screen in which the pieces of content to be selected are displayed.

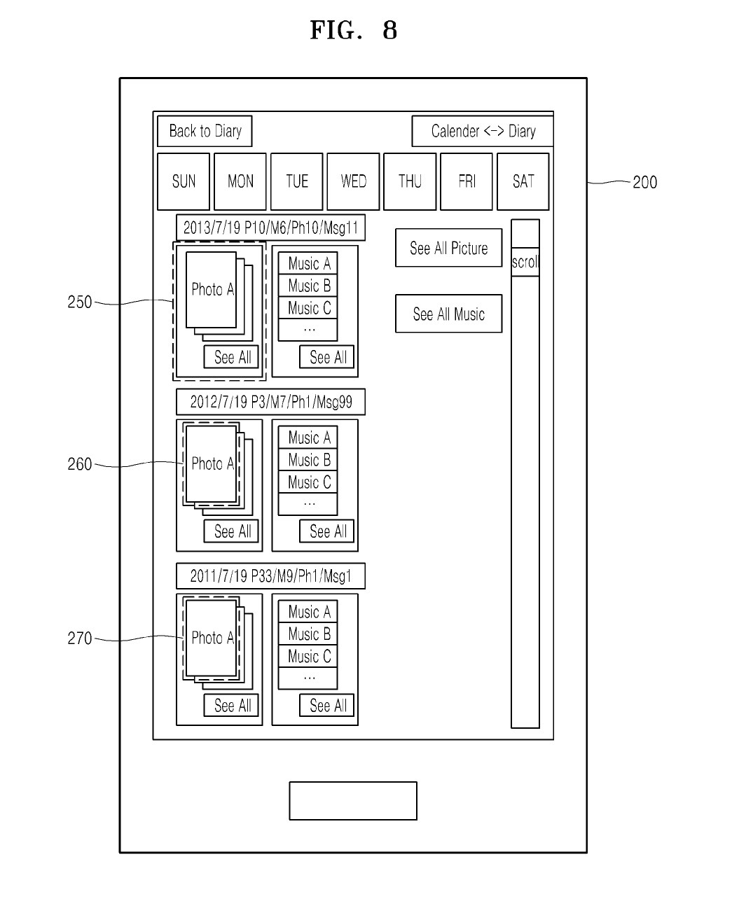

The selection of at least one of the displayed pieces of content will be described below in greater detail with reference to FIG. 8.

In operation S260, the device 100b generates an album including the selected pieces of content.

For example, the device 100b may generate at least one album selected from the group consisting of an e-book including the selected pieces of content, a motion GIF file including the selected pieces of content, and a list of the selected pieces of content.

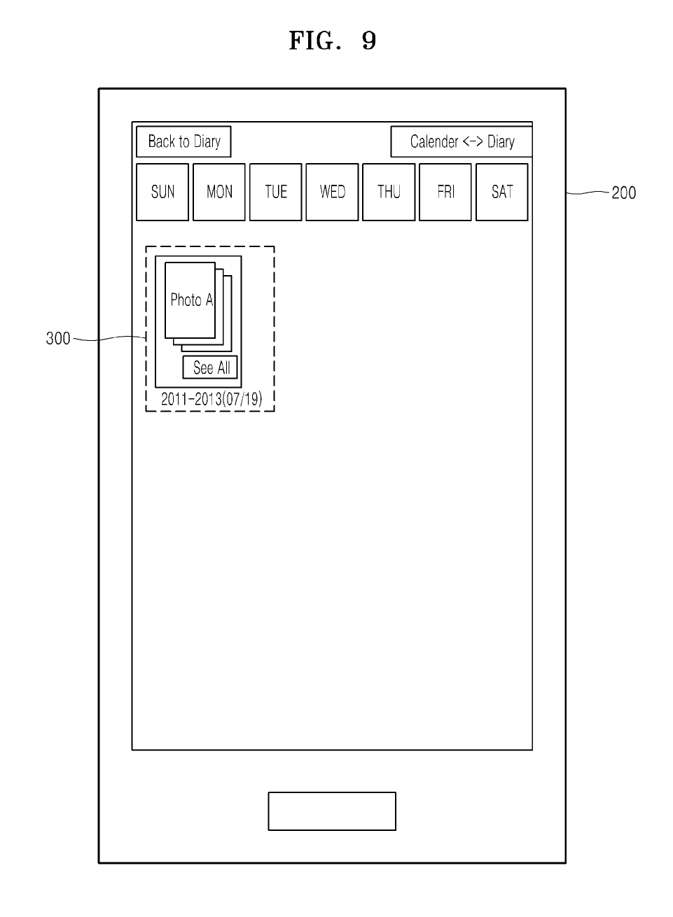

The generation of an album will be described below in greater detail with reference to FIG. 9.

FIG. 8 is an example in which at least one of a plurality of pieces of content displayed on a screen of the device 200 is selected, according to an exemplary embodiment.

As shown in FIG. 5, the device 200 may search for pieces of content related to July 19 every year and display the found pieces of content 240 on a screen of the device 200, and as shown in FIG. 8, at least one of the displayed pieces of content may be selected.

For example, the user may select at least one piece of content to be included in an album from among the displayed pieces of content. At this time, the user may select at least one of the displayed pieces of content by tapping, swiping, or flicking a certain region on the touch screen in which the pieces of content to be selected are displayed. For example, as shown in FIG. 8, content 250 including all still images related to “July 19, 2013” may be selected. Alternatively, content 260 including a portion of still images related to “July 19, 2012” may be selected, or content 270 including a portion of still images related to “July 19, 2011” may be selected.

FIG. 9 is an example in which an album 300 including pieces of content is displayed on a screen of the device 200, according to an exemplary embodiment.

The album 300, as shown in FIG. 9, may be generated to include at least one piece of content selected by the user from among pieces of content displayed on a screen of the device 200, as shown in FIG. 8. For example, as shown in FIG. 9, the album 300 including the content 250 including all still images related to “July 19, 2013”, the content 260 including a portion of still images related to “July 19, 2012”, and the content 270 including a portion of still images related to “July 19, 2011” may be generated. In this case, the album 300 may be at least one album selected from the group consisting of an e-book including the selected pieces of content, a motion GIF file including the selected pieces of content, and a list of the selected pieces of content.

For example, when at least one piece of music is selected by the user from among the pieces of content displayed on the screen of the device 200 as shown in FIG. 8, a music play list may be generated with the selected music. When an image file including still images, videos, and the like and an audio file including music and the like is included in the selected pieces of content, an album including only the image file or the audio file may be generated. Alternatively, an album including multimedia content by combining the image file and the audio file may be generated. However, one or more exemplary embodiments are not limited thereto.

One exemplary embodiment may be implemented in a form of a recording medium including instructions executable by a computer, such as program modules executed by a computer. A computer-readable medium may be an arbitrary available medium which is accessible by a computer and includes volatile and nonvolatile media and detachable and non-detachable media. In addition, the computer-readable medium may include a computer storage medium and a communication medium. The computer storage medium includes volatile and nonvolatile and detachable and non-detachable media implemented by an arbitrary method or technique for storing information, such as computer-readable instructions, data structures, program modules or other data. The communication medium typically includes computer-readable instructions, data structures, program modules, other data of a data signal modulated, such as a carrier, or other transmission mechanisms and includes an arbitrary information transfer medium.

In addition, other exemplary embodiments may also be implemented through computer-readable code/instructions in/on a medium, e.g., a computer-readable medium, to control at least one processing element to implement any above-described exemplary embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element may include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While certain exemplary embodiments have been described with reference to the figures, it will be understood by those of ordinary skill in the art that various changes in form and details may be made therein without departing from the spirit and scope of the inventive concept as defined by the following claims.

What is claimed is:

1. A method by which a device searches for content, the method comprising:
receiving a user input selecting a certain date included in a calendar displayed on a screen of the device;
displaying a menu including at least one content search condition according to the selection of the date;
receiving a user input selecting a content search condition from among the at least one content search condition included in the menu;
searching for pieces of content related to the selected date according to the selected content search condition; and
displaying found pieces of content according to a result of the searching.

2. The method of claim 1, wherein the at least one content search condition comprises at least one condition selected from the group consisting of a condition for searching for the pieces of content related to the selected date on a yearly basis and a condition for searching for the pieces of content related to the selected date on a monthly basis.

3. The method of claim 1, wherein the pieces of content related to the selected date comprise pieces of content generated on the selected date.

4. The method of claim 1, wherein the pieces of content related to the selected date comprise pieces of content reproduced by the device on the selected date.

5. The method of claim 1, wherein the displaying the found pieces of content comprises displaying the found pieces of content by sorting the found pieces of content on a yearly or monthly basis.

6. The method of claim 1, further comprising:
receiving a user input selecting at least one of the displayed pieces of content; and
generating an album comprising the selected pieces of content.

7. The method of claim 6, wherein the generating the album comprises generating at least one album selected from the group consisting of an e-book including the selected pieces of content, a motion graphics interchange format (GIF) file including the selected pieces of content, and a list of the selected pieces of content.

8. The method of claim 1, wherein the content comprises at least one content selected from the group consisting of a still image, a video, music, a call record, a text record, and a data use record.

9. The method of claim 1, wherein types of the pieces of content related to the selected date are displayed in a field in which the date included in the calendar is displayed.

10. A device comprising:
a display;
a memory configured to store at least one program; and
a processor configured to execute the at least one program to search for content,
wherein the at least one program comprises instructions which are executed by the processor to perform:
receiving a user input selecting a certain date included in a calendar displayed on a screen of the device;
displaying a menu including at least one content search condition according to the selection of the date;
receiving a user input selecting a content search condition from among the at least one content search condition included in the menu;
searching for pieces of content related to the selected date according to the selected content search condition; and
displaying on the display found pieces of content according to a result of the searching.

11. The device of claim 10, wherein the at least one content search condition comprises at least one condition selected from the group consisting of a condition for searching for the pieces of content related to the selected date on a yearly basis and a condition for searching for the pieces of content related to the selected date on a monthly basis.

12. The device of claim 10, wherein the pieces of content related to the selected date comprise pieces of content generated by the device on the selected date.

13. The device of claim 10, wherein the pieces of content related to the selected date comprise pieces of content reproduced by the device on the selected date.

14. The device of claim 10, wherein the displaying on the display the found pieces of content comprises displaying on the display the found pieces of content by sorting the found pieces of content on a yearly or monthly basis.

15. The device of claim 10, wherein the at least one program further comprises instructions which are executed by the processor to perform:
receiving a user input selecting at least one of the displayed pieces of content; and
generating an album including the selected pieces of content.

16. The device of claim 15, wherein the generating the album comprises generating at least one album selected from the group consisting of an e-book including the selected pieces of content, a motion graphics interchange format (GIF) file including the selected pieces of content, and a list of the selected pieces of content.

17. The device of claim 10, wherein the content comprises at least one content selected from the group consisting of a still image, a video, music, a call record, a text record, and a data use record.

18. The device of claim 10, wherein types of the pieces of content related to the selected date are displayed in a field in which the date included in the calendar is displayed.

19. A non-transitory computer readable medium having recorded thereon a program which, when executed by a computer, performs a method comprising:
displaying a calendar including a plurality of dates;
receiving a first input for selecting a date among the plurality of dates;
displaying a menu including at least one search condition in response to receiving the input for selecting the date;
receiving a second input for selecting a search condition among the at least one search condition;
searching for content related to the selected date and the selected search condition; and
displaying a result of the searching,
wherein the at least one search condition comprises a monthly search condition and a yearly search condition.

20. The non-transitory computer readable medium of claim 19,
wherein the plurality of dates includes a plurality of days in a specified month and specified year and the selected date corresponds to a specified day in the specified month and specified year,
wherein, in response to the monthly search condition being selected, the searching for content comprises searching for content related to the specified day in at least one month other than the specified month, and
wherein, in response to the yearly search condition being selected, the searching for content comprises searching for content related to the specified day in the specified month in at least one year other than the specified year.

21. The non-transitory computer readable medium of claim 20, wherein the content related to the selected date comprises at least one of content generated on the selected date and content reproduced on the selected date.

22. A device comprising:
a user input unit configured to receive a user input;
a display;
a memory configured to store content; and
a processor configured to:
control the display to display a calendar,
in response to the user input receiving a user input selecting a date included in the calendar displayed on the device, control the display to display a menu including at least one content search condition according to the selected date,
in response to the user input receiving a user input selecting a content search condition from among the at least one content search condition included in the menu, search the memory for pieces of content related to the selected date according to the selected content search condition, and
control the display to display found pieces of content according to a result of the searching.

23. The device of claim 22, wherein the at least one content search condition comprises at least one content search condition selected from the group consisting of a condition for searching for the pieces of content related to the selected date on a yearly basis and a condition for searching for the pieces of content related to the selected date on a monthly basis.

24. The device of claim 22, wherein the pieces of content related to the selected date comprise at least one of pieces of content generated by the device on the selected date and pieces of content reproduced by the device on the selected date.

25. The device of claim 22, wherein the processor is further configured to, in response to the user input unit receiving a user input selecting at least one of the displayed pieces of content, generate, an album including the selected pieces of content.

26. The device of claim 25, wherein the album comprises at least one of an e-book including the selected pieces of content, a motion graphics interchange format (GIF) file including the selected pieces of content, and a list of the selected pieces of content.
